(19) United States
(12) Patent Application Publication
(10) Pub. No.: US 2006/0044325 A1
(43) Pub. Date: Mar. 2, 2006

(54) Method and device for dithering

(76) Inventors: Cedric Thebault, Villingen-Schwenningen (DE); Carlos Correa, Villingen-Schwenning (DE); Sebastien Weitbruch, Niedereschach (FR)

Correspondence Address: THOMSON LICENSING INC., PATENT OPERATIONS, PO BOX 5312, PRINCETON, NJ, 08543-5312, US

(21) Appl. No.: 11/211,120

(22) Filed: Aug. 24, 2005

(30) Foreign Application Priority Data
Aug. 25, 2004 (EP) 04292087.6

(51) Int. Cl. G09G 5/00

(52) U.S. Cl. 345/613

(57) ABSTRACT

The noise occurring when applying dithering on a transfer function shall be reduced. Therefore, a first output value and a second output value are associated to a discrete input value of the transfer function. On the basis of a given number of dithering bits, an intermediate value being equal to and/or lying between the first output value and the second output value and using the least number of dithering bits is chosen. Finally this intermediate value is taken as an output value for the discrete input value. Thus, the dithering noise can be reduced tremendously.

The invention relates to a method for applying dithering to a transfer function used for processing video data. Moreover, the present invention relates to a corresponding device for applying dithering to video data.

### BACKGROUND

A PDP (plasma display panel) uses a matrix array of discharge cells, which can only be “ON”, or “OFF”. Also unlike a CRT or LCD in which grey levels are expressed by analogue control of the light emission, a PDP controls the grey level by modulating the number of light pulses per frame (sustain pulses). This time-modulation will be integrated by the eye over a period corresponding to the eye time response. Since the video amplitude is portrayed by the number of light pulses, occurring at a given frequency, more amplitude means more light pulses and thus more “ON” time. For this reason, this kind of modulation is also known as PWM, pulse width modulation.

This PWM is responsible for one of the PDP image quality problems: the poor grey scale portrayal quality, especially in the darker regions of the picture. Indeed, contrarily to CRTs where luminance is approximately quadratic to the applied cathode voltage, luminance is linear to the number of discharge pulses. Therefore an approximately digital quadratic degamma function has to be applied to video (generally done by a Look-Up Table). To avoid losing amplitude resolution due to this degamma function, a dithering method has to be used.

Dithering is a well-known technique used to reduce the effects of quantization due to a limited number of displayed resolution bits. There are mainly two kinds of dithering used for PDP:
Matrix dithering (Cf. Cell-Based dithering in patent application EP1269457, and its enhanced version Multi-Mask dithering in patent application EP1262947), which improves gray scale portrayal but adds some dither pattern (structured noise).
Error-Diffusion, which improves gray scale portrayal and generates no dither pattern, but adds some noise.

The teaching of the present document aims at reducing the dithering noise appearing with matrix dithering. Error diffusion noise cannot be reduced by the method described here.

Matrix dithering can in principle bring back as many bits as wanted. However, the dithering noise frequency decreases and therefore the noise becomes more noticeable with an increasing number of dithering bits. In practice with matrix dithering, 3 bits of dithering can be used at the most, because the more bits one uses, the more visible the pattern is.

The reason for this is that if 3 bits are used for dithering, there will be 8 different dithering patterns, as shown in FIG. 1, and the repetition time of a pattern takes 8 clock units. Thus, the repetition frequency of the dithering patterns is low. If more than 3 bits are used for dithering, the repetition frequency will be too low and not acceptable. If only 2 bits of dithering are used, the repetition frequency of the dithering patterns will be two times as high as the repetition frequency of 3 bits dithering.

Another aspect is that if 3 bits of dithering are used, the pattern of ½(1st bit of dithering) is quite invisible, the patterns of ¼and ¾(2nd bit of dithering) are a bit more visible, while the patterns of ⅛, ⅜, ⅝ and ⅞ (3rd bit of dithering) can be more visible and awkward (compare FIG. 1). For example, in case of standard cell-based dithering (patent application EP1269457), the integration of 4 frames of dithering gives the levels shown in FIG. 1.

The values 0, ¼, ½, ¾ and 1 in each cell of the 4×4 matrix dithering blocks mean that the level 1 is activated 0, 1, 2, 3 or 4 times during the 4 frames. According to this example, the levels ⅛, ⅜, ⅝ and ⅞ are less fine (and so more visible and cumbersome) than the others patterns of dithering.

The typical block structure of the data processing before the coding step is shown in FIG. 2. 8 bit input data YI are fed into a degamma block 1. The degamma function is realized with the aid of a look-up table LUT#1. An 11 bit output signal YA is transmitted to a matrix dithering block 2. An 8 bit output signal YB from the matrix dithering block 2 is input into a transcoding block 3 applying a second look-up table LUT#2. The resulting output signal after the coding step includes 16 bit data.

The choice of a dither pattern is made by the degamma LUT, where the dithering bits appear. The matrix dithering block only applies the matrix pattern corresponding to the dithering bits.

The problem is that dithering bits are really required in the low levels (because of the degamma function), but in the higher levels they are not really necessary, and can on the contrary be unwanted since they add some patterns without adding levels. This will be better explained by an example. The degamma function is defined as follows:

$${Y}_{A} = 255 \times {( \frac{{Y}_{I}}{255} )}^{γ} ,$$

wherein Y_{I} is the input data and Y_{A} the output data of the degamma block 1. Y is the usual exponent of the degamma function. In the example Y=2.2

Even with 3 bits of dithering, some levels between 0 and 21 have the same output, which means loss of levels. But after level 122, all outputs are different even without dithering. This means that without dithering there is no loss of levels but without dithering there is also more quantization noise.

In the higher levels, dithering can be useful to reduce quantization noise, but it is not necessary to have 3 bits of dithering. However, for example, input levels between 182 and 189 are all using the 3rd bit of dithering as shown in Table 1, which is an extract of Table 3 given in Annex.

TABLE 1

| Input | Output |
|---|---|
| 8 bit | 8.3 bit |
| 182 | 121,375 |
| 183 | 122,875 |
| 184 | 124,375 |
| 185 | 125,875 |
| 186 | 127,375 |
| 187 | 128,875 |
| 188 | 130,375 |
| 189 | 131,875 |

So for these high levels dither patterns are used, which can be awkward.

### INVENTION

In view of that, the object of the present invention is to provide a method and a device which enable an improved dithering of quantization steps.

According to the present invention this object is solved by a method for processing video data by applying a transfer function on said video data, a dithering being applied to said transfer function. For applying said dithering to the transfer function, the method comprises the following steps:
applying dithering to a transfer function used for processing video data by associating a first output value and a second output value to a discrete input value of said transfer function,
choosing an intermediate value being equal to and/or lying between said first output value and said second output value, said intermediate value using the least number of dithering bits and
taking said intermediate value as an output value for said discrete input value.

For example, if output values are 12.125 and 12.875, the values equal to and/or lying between these output values are:
12.125 (decimal) equal to 1100.001 (binary representation of a float number)
12.25 (decimal) equal to 1100.01 (binary),
12.375 (decimal) is equal to 1100.011 (binary),
12.5 (decimal) is equal to 1100.1 (binary),
12.625 (decimal) is equal to 1100.101 (binary),
12.75 (decimal) is equal to 1100.11 (binary),
12.875 (decimal) is equal to 1100.111 (binary)

The intermediate value using the least number of bits is 12.5.

Furthermore, there is provided a device for processing video data having processing means for applying a transfer function on said video data and dithering means for applying dithering to said transfer function, wherein said dithering means associates a first output value and a second output value to a discrete input value of said transfer function, chooses an intermediate value being equal to and/or lying between said first output value and said second output value that uses the least number of dithering bits and takes said intermediate value as an output value for said discrete input value.

The advantage of the inventive method and device is that the dithering noise can be reduced tremendously.

The transfer function may be a degamma function. The effect of the quantization of the degamma function is often very disturbing. Thus, an improved dithering of the degamma function values has a very positively effect.

The transfer function may be provided by a look-up table. Such LUT improves the processing speed.

In a specific embodiment the first and the second output values are calculated by modifying a parameter of the transfer function. Especially, the input parameter of the transfer function may be modified. The modification may be performed by adding and subtracting a modifying value to or from the parameter, so that the first and the second output values are obtained by the modified parameter. By doing so an acceptable error will be specified.

If there are a plurality of intermediate values with the same least number of used dithering bits, the value which lies closer to the discrete function value may be chosen as intermediate value. With that, further errors are avoided.

### DRAWINGS

The present invention is illustrated along with the attached drawings showing in:

FIG. 1 matrix dithering blocks for cell based dithering;

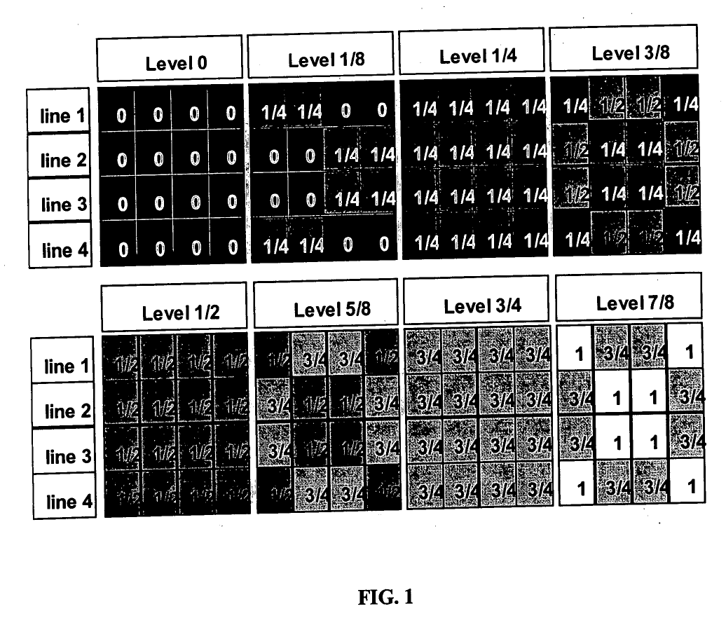

FIG. 2 a block diagram of the data processing before the encoding step according to the prior art; and

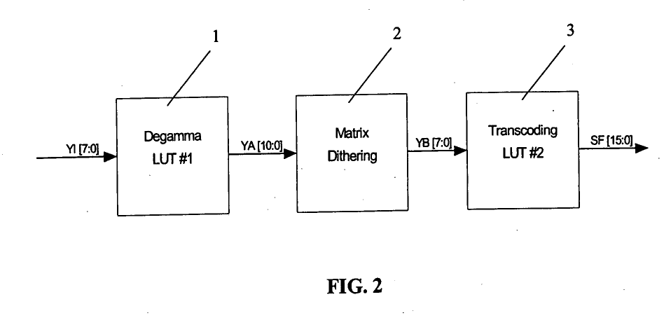

FIG. 3 a flow chart of the inventive method.

### EXEMPLARY EMBODIMENTS

The present invention is based on the following knowledge.

Only a small shift of 0.05 of the input, which corresponds to a small error on the input, would lead to levels using only 1 bit of dithering. So worse dither pattern indicated in table 1 can be avoided without adding significant quantization noise, as shown in the following table 2.

TABLE 2

| | Output |
|---|---|
| Input | 8.3 bit |
| 182,05 | 121,5 |
| 183,05 | 123 |
| 184,05 | 124,5 |
| 185,05 | 126 |
| 186,05 | 127,5 |
| 187,05 | 129 |
| 188,05 | 130,5 |
| 189,05 | 132 |

In fact, globally the rounding process makes the probability that the value added by dithering is equal either to 0/8, ⅛, 2/8, ⅜, 4/8, ⅝, 6/8, or ⅞ the same for all levels. So, in principle, the probability that a level uses the 3rd dithering bit (i.e. value added by dithering is equal to ⅛, ⅜, ⅝ or ⅞) is ½.

When generating the degamma LUT, there are always rounding errors. Now, the idea is to play on this error in order to privilege better dither patterns. In other words, the error has to be estimated and limited.

The error on the output (quantization error) is not easy to estimate because this error is always relatively smaller in the higher levels than in the low levels (in case of standard encoding). The estimation is worse in case of Gravity Center Coding (cf. patent application EP1256924) or Metacode (cf. patent application EP1353315), because of the non uniform distribution of the levels and the resulting non-uniformity of the quantization error.

For these reasons, it is easier to consider an error on the input. Specifically, it is easier to estimate and to limit the error.

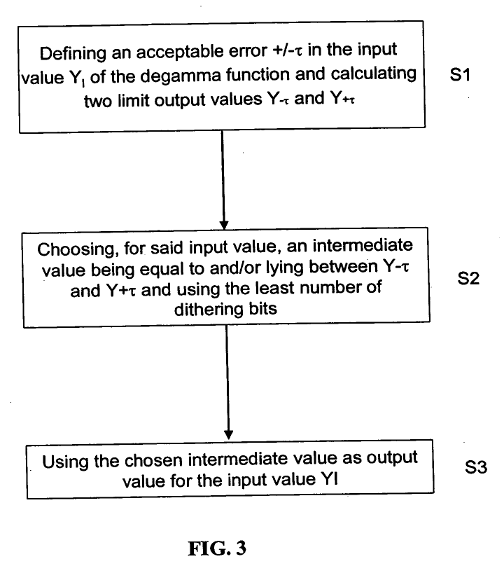

So the first step S1 as shown in FIG. 3 is to decide the limit τ of the error which will be accepted. A possible value for τ might be 0, 1. Two limit curves of the degamma function are defined as follows:

$${Y}_{- τ} = 255 \times {( \frac{{Y}_{I} - τ}{255} )}^{γ} and {Y}_{+ τ} = 255 \times {( \frac{{Y}_{I} + τ}{255} )}^{γ}$$

With this two limit curves, two output values Y_{-τ} and Y_{+τ} other than the value Y_{A} can be defined for each input value Y_{I}. Table 3, given in Annex, shows the corresponding input values Y_{I} (first column) and output values Y_{A} (second and fifth column) of the degamma block 1. The third and fourth column of Table 3 represent the values Y_{-τ} and Y_{+τ} of the limit curves. Each degamma output value consists of a 8 bit integer and a 3 bit dithering value.

According to the present invention for each input value an intermediate value between Y−τ and Y+τ using the least dithering bits is chosen (compare step S2). This can be seen for instance in the rows of input values 20 and 30. Said intermediate value is chosen as output value for the considered input value Y_{I}. When there are different values having the same number of dithering bits, the closer to the real value has to be chosen. However, if for an actual input value there is an output value between Y−τ and Y+τ having less dithering that the values Y−τ and Y+τ, this value must be chosen. The row of input value 146 shows such an example. Additionally, it has to be regarded to use different output values as far as possible (compare optimized output values for the input values 26 and 27).

With the standard method (compare second column of Table 3) 131 levels (respectively 61, 28 and 36) are using the 3rd dithering bit (respectively 2nd, 1st and no dithering bit), with the inventively optimized approach only 28 (respectively 63 and 70, and 95).

The invention can be applied to presently available processing devices without hardware amendment, because only a change of the content of the LUT is necessary. However, advanced processing devices may be able to calculate the optimized LUT automatically. In this case specific calculation means are necessary to perform the method shown in FIG. 3.

### Annex

TABLE 3
(γ = 2.2 and τ = 0.1)

deGamma Output (8.3 bit)

| Input | without | | | with |
|---|---|---|---|---|
| (8 bit) | optimization | γ_{-τ} | γ_{+τ} | optimization |
| 0 | 0 | 0 | 0 | 0 |
| 1 | 0 | 0 | 0 | 0 |
| 2 | 0 | 0 | 0 | 0 |
| 3 | 0 | 0 | 0 | 0 |
| 4 | 0 | 0 | 0 | 0 |
| 5 | 0 | 0 | 0 | 0 |
| 6 | 0.125 | 0.125 | 0.125 | 0.125 |
| 7 | 0.125 | 0.125 | 0.125 | 0.125 |
| 8 | 0.125 | 0.125 | 0.125 | 0.125 |
| 9 | 0.125 | 0.125 | 0.125 | 0.125 |
| 10 | 0.25 | 0.25 | 0.25 | 0.25 |
| 11 | 0.25 | 0.25 | 0.25 | 0.25 |
| 12 | 0.25 | 0.25 | 0.25 | 0.25 |
| 13 | 0.375 | 0.375 | 0.375 | 0.375 |
| 14 | 0.375 | 0.375 | 0.375 | 0.375 |
| 15 | 0.5 | 0.5 | 0.5 | 0.5 |
| 16 | 0.625 | 0.625 | 0.625 | 0.625 |
| 17 | 0.625 | 0.625 | 0.625 | 0.625 |
| 18 | 0.75 | 0.75 | 0.75 | 0.75 |
| 19 | 0.875 | 0.875 | 0.875 | 0.875 |
| 20 | 1 | 0.875 | 1 | 1 |
| 21 | 1 | 1 | 1 | 1 |
| 22 | 1.125 | 1.125 | 1.125 | 1.125 |
| 23 | 1.25 | 1.25 | 1.25 | 1.25 |
| 24 | 1.375 | 1.375 | 1.375 | 1.375 |
| 25 | 1.5 | 1.5 | 1.5 | 1.5 |
| 26 | 1.625 | 1.625 | 1.75 | 1.625 |
| 27 | 1.875 | 1.75 | 1.875 | 1.75 |
| 28 | 2 | 2 | 2 | 2 |
| 29 | 2.125 | 2.125 | 2.125 | 2.125 |
| 30 | 2.25 | 2.25 | 2.375 | 2.25 |
| 31 | 2.5 | 2.5 | 2.5 | 2.5 |
| 32 | 2.625 | 2.625 | 2.625 | 2.625 |
| 33 | 2.875 | 2.875 | 2.875 | 2.875 |
| 34 | 3 | 3 | 3 | 3 |
| 35 | 3.25 | 3.25 | 3.25 | 3.25 |
| 36 | 3.375 | 3.375 | 3.5 | 3.5 |
| 37 | 3.625 | 3.625 | 3.625 | 3.625 |
| 38 | 3.875 | 3.875 | 3.875 | 3.875 |
| 39 | 4.125 | 4.125 | 4.125 | 4.125 |
| 40 | 4.375 | 4.25 | 4.375 | 4.25 |
| 41 | 4.625 | 4.5 | 4.625 | 4.5 |
| 42 | 4.875 | 4.75 | 4.875 | 4.75 |
| 43 | 5.125 | 5 | 5.125 | 5 |
| 44 | 5.375 | 5.375 | 5.375 | 5.375 |
| 45 | 5.625 | 5.625 | 5.625 | 5.625 |
| 46 | 5.875 | 5.875 | 5.875 | 5.875 |
| 47 | 6.125 | 6.125 | 6.25 | 6.25 |
| 48 | 6.5 | 6.5 | 6.5 | 6.5 |
| 49 | 6.75 | 6.75 | 6.75 | 6.75 |
| 50 | 7.125 | 7 | 7.125 | 7 |
| 51 | 7.375 | 7.375 | 7.375 | 7.375 |
| 52 | 7.75 | 7.625 | 7.75 | 7.625 |
| 53 | 8 | 8 | 8.125 | 8 |
| 54 | 8.375 | 8.375 | 8.375 | 8.375 |
| 55 | 8.75 | 8.75 | 8.75 | 8.75 |
| 56 | 9.125 | 9 | 9.125 | 9 |
| 57 | 9.5 | 9.375 | 9.5 | 9.5 |
| 58 | 9.75 | 9.75 | 9.875 | 9.75 |
| 59 | 10.125 | 10.125 | 10.25 | 10.25 |
| 60 | 10.625 | 10.5 | 10.625 | 10.5 |
| 61 | 11 | 10.875 | 11 | 11 |
| 62 | 11.375 | 11.375 | 11.375 | 11.375 |
| 63 | 11.75 | 11.75 | 11.75 | 11.75 |
| 64 | 12.125 | 12.125 | 12.25 | 12.25 |
| 65 | 12.625 | 12.625 | 12.625 | 12.625 |
| 66 | 13 | 13 | 13.125 | 13 |
| 67 | 13.5 | 13.375 | 13.5 | 13.5 |
| 68 | 13.875 | 13.875 | 14 | 14 |
| 69 | 14.375 | 14.375 | 14.375 | 14.375 |
| 70 | 14.875 | 14.75 | 14.875 | 14.75 |
| 71 | 15.25 | 15.25 | 15.375 | 15.25 |
| 72 | 15.75 | 15.75 | 15.875 | 15.75 |
| 73 | 16.25 | 16.25 | 16.375 | 16.25 |
| 74 | 16.75 | 16.75 | 16.875 | 16.75 |
| 75 | 17.25 | 17.25 | 17.375 | 17.25 |
| 76 | 17.75 | 17.75 | 17.875 | 17.75 |
| 77 | 18.25 | 18.25 | 18.375 | 18.25 |
| 78 | 18.875 | 18.75 | 18.875 | 18.75 |
| 79 | 19.375 | 19.25 | 19.375 | 19.25 |
| 80 | 19.875 | 19.875 | 20 | 20 |
| 81 | 20.5 | 20.375 | 20.5 | 20.5 |
| 82 | 21 | 21 | 21.125 | 21 |
| 83 | 21.625 | 21.5 | 21.625 | 21.5 |
| 84 | 22.125 | 22.125 | 22.25 | 22.25 |
| 85 | 22.75 | 22.625 | 22.75 | 22.75 |
| 86 | 23.375 | 23.25 | 23.375 | 23.25 |
| 87 | 24 | 23.875 | 24 | 24 |
| 88 | 24.5 | 24.5 | 24.625 | 24.5 |
| 89 | 25.125 | 25.125 | 25.25 | 25.25 |
| 90 | 25.75 | 25.75 | 25.875 | 25.75 |
| 91 | 26.375 | 26.375 | 26.5 | 26.5 |
| 92 | 27.125 | 27 | 27.125 | 27 |
| 93 | 27.75 | 27.625 | 27.75 | 27.75 |
| 94 | 28.375 | 28.375 | 28.5 | 28.5 |
| 95 | 29 | 29 | 29.125 | 29 |
| 96 | 29.75 | 29.625 | 29.75 | 29.75 |
| 97 | 30.375 | 30.375 | 30.5 | 30.5 |
| 98 | 31.125 | 31 | 31.125 | 31 |
| 99 | 31.75 | 31.75 | 31.875 | 31.75 |
| 100 | 32.5 | 32.5 | 32.625 | 32.5 |
| 101 | 33.25 | 33.125 | 33.25 | 33.25 |
| 102 | 34 | 33.875 | 34 | 34 |
| 103 | 34.75 | 34.625 | 34.75 | 34.75 |
| 104 | 35.5 | 35.375 | 35.5 | 35.5 |
| 105 | 36.25 | 36.125 | 36.25 | 36.25 |
| 106 | 37 | 36.875 | 37 | 37 |
| 107 | 37.75 | 37.625 | 37.875 | 37.625 |
| 108 | 38.5 | 38.5 | 38.625 | 38.5 |
| 109 | 39.25 | 39.25 | 39.375 | 39.25 |
| 110 | 40.125 | 40 | 40.125 | 40 |
| 111 | 40.875 | 40.875 | 41 | 41 |
| 112 | 41.75 | 41.625 | 41.75 | 41.75 |
| 113 | 42.5 | 42.5 | 42.625 | 42.5 |
| 114 | 43.375 | 43.25 | 43.5 | 43.5 |
| 115 | 44.25 | 44.125 | 44.25 | 44.25 |
| 116 | 45.125 | 45 | 45.125 | 45 |
| 117 | 45.875 | 45.875 | 46 | 46 |
| 118 | 46.75 | 46.75 | 46.875 | 46.75 |
| 119 | 47.625 | 47.625 | 47.75 | 47.75 |
| 120 | 48.625 | 48.5 | 48.625 | 48.5 |
| 121 | 49.5 | 49.375 | 49.5 | 49.5 |
| 122 | 50.375 | 50.25 | 50.5 | 50.5 |
| 123 | 51.25 | 51.25 | 51.375 | 51.25 |
| 124 | 52.25 | 52.125 | 52.25 | 52.25 |
| 125 | 53.125 | 53 | 53.25 | 53 |
| 126 | 54.125 | 54 | 54.125 | 54 |
| 127 | 55 | 54.875 | 55.125 | 55 |
| 128 | 56 | 55.875 | 56.125 | 56 |
| 129 | 57 | 56.875 | 57 | 57 |
| 130 | 57.875 | 57.875 | 58 | 58 |
| 131 | 58.875 | 58.75 | 59 | 59 |
| 132 | 59.875 | 59.75 | 60 | 60 |
| 133 | 60.875 | 60.75 | 61 | 61 |
| 134 | 61.875 | 61.75 | 62 | 62 |
| 135 | 62.875 | 62.875 | 63 | 63 |
| 136 | 64 | 63.875 | 64.125 | 64 |
| 137 | 65 | 64.875 | 65.125 | 65 |
| 138 | 66 | 66 | 66.125 | 66 |
| 139 | 67.125 | 67 | 67.25 | 67 |
| 140 | 68.125 | 68.125 | 68.25 | 68.25 |
| 141 | 69.25 | 69.125 | 69.375 | 69.25 |
| 142 | 70.375 | 70.25 | 70.5 | 70.5 |
| 143 | 71.375 | 71.375 | 71.5 | 71.5 |
| 144 | 72.5 | 72.375 | 72.625 | 72.5 |
| 145 | 73.625 | 73.5 | 73.75 | 73.5 |
| 146 | 74.75 | 74.625 | 74.875 | 74.75 |
| 147 | 75.875 | 75.75 | 76 | 75.75 |
| 148 | 77 | 76.875 | 77.125 | 77 |
| 149 | 78.25 | 78.125 | 78.25 | 78.25 |
| 150 | 79.375 | 79.25 | 79.5 | 79.5 |
| 151 | 80.5 | 80.375 | 80.625 | 80.5 |
| 152 | 81.75 | 81.625 | 81.875 | 81.75 |
| 153 | 82.875 | 82.75 | 83 | 83 |
| 154 | 84.125 | 84 | 84.25 | 84 |
| 155 | 85.25 | 85.125 | 85.375 | 85.25 |
| 156 | 86.5 | 86.375 | 86.625 | 86.5 |
| 157 | 87.75 | 87.625 | 87.875 | 87.75 |
| 158 | 89 | 88.875 | 89.125 | 89 |
| 159 | 90.25 | 90.125 | 90.375 | 90.25 |
| 160 | 91.5 | 91.375 | 91.625 | 91.5 |
| 161 | 92.75 | 92.625 | 92.875 | 92.75 |
| 162 | 94 | 93.875 | 94.125 | 94 |
| 163 | 95.25 | 95.125 | 95.375 | 95.25 |
| 164 | 96.5 | 96.375 | 96.75 | 96.5 |
| 165 | 97.875 | 97.75 | 98 | 98 |
| 166 | 99.125 | 99 | 99.25 | 99 |
| 167 | 100.5 | 100.375 | 100.625 | 100.5 |
| 168 | 101.875 | 101.625 | 102 | 102 |
| 169 | 103.125 | 103 | 103.25 | 103 |
| 170 | 104.5 | 104.375 | 104.625 | 104.5 |
| 171 | 105.875 | 105.75 | 106 | 106 |
| 172 | 107.25 | 107.125 | 107.375 | 107.25 |
| 173 | 108.625 | 108.5 | 108.75 | 108.5 |
| 174 | 110 | 109.875 | 110.125 | 110 |
| 175 | 111.375 | 111.25 | 111.5 | 111.5 |
| 176 | 112.75 | 112.625 | 112.875 | 112.75 |
| 177 | 114.25 | 114.125 | 114.375 | 114.25 |
| 178 | 115.625 | 115.5 | 115.75 | 115.5 |
| 179 | 117.125 | 116.875 | 117.25 | 117 |
| 180 | 118.5 | 118.375 | 118.625 | 118.5 |
| 181 | 120 | 119.875 | 120.125 | 120 |
| 182 | 121.375 | 121.25 | 121.625 | 121.5 |
| 183 | 122.875 | 122.75 | 123 | 123 |
| 184 | 124.375 | 124.25 | 124.5 | 124.5 |
| 185 | 125.875 | 125.75 | 126 | 126 |
| 186 | 127.375 | 127.25 | 127.5 | 127.5 |
| 187 | 128.875 | 128.75 | 129 | 129 |
| 188 | 130.375 | 130.25 | 130.5 | 130.5 |
| 189 | 131.875 | 131.75 | 132.125 | 132 |
| 190 | 133.5 | 133.375 | 133.625 | 133.5 |
| 191 | 135 | 134.875 | 135.125 | 135 |
| 192 | 136.625 | 136.375 | 136.75 | 136.5 |
| 193 | 138.125 | 138 | 138.375 | 138 |
| 194 | 139.75 | 139.625 | 139.875 | 139.75 |
| 195 | 141.375 | 141.125 | 141.5 | 141.25 |
| 196 | 142.875 | 142.75 | 143.125 | 143 |
| 197 | 144.5 | 144.375 | 144.75 | 144.5 |
| 198 | 146.125 | 146 | 146.375 | 146 |
| 199 | 147.75 | 147.625 | 148 | 148 |
| 200 | 149.375 | 149.25 | 149.625 | 149.5 |
| 201 | 151.125 | 150.875 | 151.25 | 151 |
| 202 | 152.75 | 152.625 | 152.875 | 152.75 |
| 203 | 154.375 | 154.25 | 154.625 | 154.5 |
| 204 | 156.125 | 155.875 | 156.25 | 156 |
| 205 | 157.75 | 157.625 | 157.875 | 157.75 |
| 206 | 159.5 | 159.25 | 159.625 | 159.5 |
| 207 | 161.125 | 161 | 161.375 | 161 |
| 208 | 162.875 | 162.75 | 163 | 163 |
| 209 | 164.625 | 164.5 | 164.75 | 164.5 |
| 210 | 166.375 | 166.125 | 166.5 | 166.5 |
| 211 | 168.125 | 167.875 | 168.25 | 168 |
| 212 | 169.875 | 169.625 | 170 | 170 |
| 213 | 171.625 | 171.5 | 171.75 | 171.5 |
| 214 | 173.375 | 173.25 | 173.625 | 173.5 |
| 215 | 175.25 | 175 | 175.375 | 175 |
| 216 | 177 | 176.75 | 177.125 | 177 |
| 217 | 178.75 | 178.625 | 179 | 179 |
| 218 | 180.625 | 180.375 | 180.75 | 180.5 |
| 219 | 182.5 | 182.25 | 182.625 | 182.5 |
| 220 | 184.25 | 184.125 | 184.5 | 184.5 |
| 221 | 186.125 | 186 | 186.375 | 186 |
| 222 | 188 | 187.75 | 188.125 | 188 |
| 223 | 189.875 | 189.625 | 190 | 190 |
| 224 | 191.75 | 191.5 | 191.875 | 191.5 |
| 225 | 193.625 | 193.375 | 193.75 | 193.5 |
| 226 | 195.5 | 195.375 | 195.75 | 195.5 |
| 227 | 197.375 | 197.25 | 197.625 | 197.5 |
| 228 | 199.375 | 199.125 | 199.5 | 199.5 |
| 229 | 201.25 | 201.125 | 201.5 | 201.5 |
| 230 | 203.25 | 203 | 203.375 | 203 |
| 231 | 205.125 | 205 | 205.375 | 205 |
| 232 | 207.125 | 206.875 | 207.375 | 207 |
| 233 | 209.125 | 208.875 | 209.25 | 209 |
| 234 | 211.125 | 210.875 | 211.25 | 211 |
| 235 | 213 | 212.875 | 213.25 | 213 |
| 236 | 215 | 214.875 | 215.25 | 215 |
| 237 | 217.125 | 216.875 | 217.25 | 217 |
| 238 | 219.125 | 218.875 | 219.25 | 219 |
| 239 | 221.125 | 220.875 | 221.375 | 221 |
| 240 | 223.125 | 223 | 223.375 | 223 |
| 241 | 225.25 | 225 | 225.375 | 225 |
| 242 | 227.25 | 227.125 | 227.5 | 227.5 |
| 243 | 229.375 | 229.125 | 229.5 | 229.5 |
| 244 | 231.375 | 231.25 | 231.625 | 231.5 |
| 245 | 233.5 | 233.25 | 233.75 | 233.5 |
| 246 | 235.625 | 235.375 | 235.875 | 235.5 |
| 247 | 237.75 | 237.5 | 238 | 237.5 |
| 248 | 239.875 | 239.625 | 240.125 | 240 |
| 249 | 242 | 241.75 | 242.25 | 242 |
| 250 | 244.125 | 243.875 | 244.375 | 244 |
| 251 | 246.25 | 246.125 | 246.5 | 246.5 |
| 252 | 248.5 | 248.25 | 248.625 | 248.5 |
| 253 | 250.625 | 250.375 | 250.875 | 250.5 |
| 254 | 252.75 | 252.625 | 253 | 253 |
| 255 | 255 | 254.75 | 255.25 | 255 |

1. Method for processing video data by applying a transfer function on said video data, a dithering being applied to said transfer function, wherein for applying said dithering to the transfer function, it comprises the following steps
associating a first output value and a second output value to a discrete input value of said transfer function,
choosing an intermediate value being equal to and/or lying between said first output value and said second output value, said intermediate value using the least number of dithering bits and
taking said intermediate value as an output value for said discrete input value.

2. Method according to claim 1, wherein said transfer function is a degamma function.

3. Method according to claim 1, wherein said transfer function is provided by a look-up table.

4. Method according to claim 1, wherein said first and second output values are calculated by modifying a parameter of the transfer function.

5. Method according to claim 4, wherein said parameter is modified by adding and subtracting a modifying value to or from said parameter, and said first and second output values are obtained by said modified parameter.

6. Method according to claim 1, wherein, if there are a plurality of intermediate values with the same least number of used dithering bits, the value which lies closer to said discrete function value is chosen as intermediate value.

7. Device for processing video data having
processing means for applying a transfer function on said video data and
dithering means for applying dithering to said transfer function,
wherein
said dithering means associates a first output value and a second output value to a discrete input value of said transfer function, chooses an intermediate value being equal to and/or lying between said first output value and said second output value that uses the least number of dithering bits and takes said intermediate value as an output value for said discrete input value.

8. Device according to claim 7, wherein said transfer function is a degamma function.

9. Device according to claim 7, having storing means for providing said transfer function in a look-up table.

10. Device according to claim 7, wherein said dithering means is suitable for calculating said first and said second output values by modifying a parameter of the transfer function.
